(19) United States
(12) Patent Application Publication
(10) Pub. No.: US 2009/0210365 A1
(43) Pub. Date: Aug. 20, 2009

(54) System and method for combining hetergeneous predictors with an application to survival anaylsis

(75) Inventor: Marina Sapir, Mamaroneck, NY (US)

Correspondence Address: MINTZ LEVIN COHN FERRIS GLOVSKY & POPEO, ONE FINANCIAL CENTER, BOSTON, MA, 02111, US

(73) Assignee: AUREON LABORATORIES, INC., Yonkers, NY (US)

(21) Appl. No.: 12/322,973

(22) Filed: Feb. 9, 2009

Related U.S. Application Data
(60) Provisional application No. 61/065,188, filed on Feb. 7, 2008.

(51) Int. Cl. G06F 15/18

(52) U.S. Cl. 706/12

(57) ABSTRACT

A method, a system, and a computer-readable medium for predicting a risk in a survival analysis for a plurality of individuals characterized by at least one predictor are disclosed. A method for estimating risk order of an individual, given information about a set of individuals, characterized by one or many predictors, and provided that direction of association between each predictor and the risk order is known, comprising the step of comparing the individual with each individual within the set of individuals, and estimating risk of individual based on set comparisons.

### CROSS-REFERENCE TO RELATED APPLICATIONS

The present application claims priority to the U.S. Provisional Patent Application Ser. No. 61/065,188, to Sapir, filed Feb. 7, 2008, and entitled “Combining Continuous Predictors with Application to Survival Analysis”, the disclosure of which is incorporated herein by reference in its entirety.

### BACKGROUND OF THE INVENTION

1. Field of the Invention

Embodiments of the present invention relate to methods and systems in the field of survival analysis. In particular, the present invention relates to systems and methods for predicting risk of failure of individuals characterized by a plurality of predictors or features.

2. Background

Computer algorithms for supporting decisions under uncertainty have been developed in the area of machine learning. Generally, machine learning methods (e.g., support vector machines (SVM) and neural networks) generate a mathematical model that defines dependencies between the descriptive data and labels (i.e., outcomes) of known cases. The mathematical model is then applied to the description of a new case in order to make a decision about its class.

In survival analysis, the ultimate goal is to find dependence of individual risk of failure on clinical and pathological characteristics of patients. The specifics of the survival analysis problem is that many individuals do not have a failure. For example, only about one in ten patients with prostate cancer has metastases after prostatectomy during time under observation. The order of risk of individuals without observed failure is not known. The information about risk order is often insufficient to build a reliable rule for predicting risk of new patients.

One example of conventional learning method for the survival analysis is the Cox proportional hazard regression. The Cox regression was used in many medical applications for the purposes of predicting risk. However, as has been shown by other studies, the Cox methodology often failed to converge and its performance suffered in situations where a large number of features was present characterizing a set of individuals (see, e.g., Khan, Faisal M. and Zubek, Valentina Bayer, “Support Vector Regression for Censored Data (SVRc): A Novel Tool for Survival Analysis”, Proceedings of the Eighth IEEE International Conference on Data Mining ICDM 2008, December 2008, pp. 863-868).

The present invention proposes to circumvent limitation of conventional approach with the use of expert knowledge about association of the descriptive features with the latent risk of failure. In survival analysis, usually, features are selected as related to the risk of failure. Most times, the features are known from theory or previous experience of predicting failure. The features are called predictors.

Using this additional information about predictors, the present invention proposes to approach the above problem as an “unsupervised” aggregation of predictors. In this approach, the information about failure times is not used to evaluate the risk of an individual. Instead, expert knowledge about the predictors' association with a risk of failure is utilized. Similarly to conventional systems, in the present invention, data about failure times is used to evaluate performance of the method.

Some of the existing approaches to the combination of “criteria” or “preferences” (see, e.g., Ailon, N., Charikar, M., and Newman, A., “Aggregating inconsistent information: ranking and clustering. In STOC 05: Proceedings of the thirty-seventh annual ACM symposium on Theory of computing”, ACM Press, New York, N.Y., USA, 2005, pages 684-693; Wittkowski, K. M., et al., “Combining several ordinal measures in clinical studies”, Stat. Med., 23, 2004, pp. 1579-1592) define a comparison on individuals or cases based on values of criteria and then build a scoring function using these comparisons. These approaches determine the order using obtained scores. However, these methods are not intended for problems with continuous predictors.

Traditional aggregation methods consider any differences in feature values as being important. With continuous predictors, which are common in medical applications, small variations of feature values are likely to be related to noise and could be ignored. The goals of the traditional approaches of the criteria aggregations are limited to ordering observations within a given set of data, but they are not intended to characterize the latent order on a general population.

Conventional criteria aggregation methods assume that no independent information about the “true” order is given, thus, there is no requirement to learn the “true” order. In a survival analysis, such requirement is critical. The present invention provides a solution to this problem by introducing a reliable and robust method for combining heterogeneous predictors. It is proven that the method can be used to approximate the latent risk order of individuals.

### SUMMARY OF THE INVENTION

In some embodiments, the present invention relates to a method for estimating a risk order of an individual, given information about a set of individuals, characterized by one or many predictors, and provided that a direction of association between each predictor and the risk order is known. The method includes comparing the individual with each individual within the set of individuals, and, estimating a risk of an individual based on the comparison.

In some embodiments, the present invention relates to computer-readable medium encoded with computer program instructions for performing a method for predicting a risk in a survival analysis for a plurality of individuals characterized by at least one predictor, The method includes performing the following procedures: a Univariate Shift Procedure, wherein a measure of distance between each pair of individuals by a single predictor is calculated; a Multi-dimensional Order Procedure, wherein a pair of individuals is ordered, based on univariate shifts; and a Scoring Procedure, wherein a score for an individual is calculated.

Further features and advantages of the invention, as well as structure and operation of various embodiments of the invention, are disclosed in detail below with references to the accompanying drawings.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIGS. 1a-b illustrate an exemplary method for estimating a risk order, according to some embodiments of the present invention.

FIG. 2 is an exemplary plot illustrating of a robust performance of the present invention's method in statistical simulation using different sets of predictors (e.g., 10 predictors, 20 predictors, and 30 predictors) versus the existing Cox model, when the predictors have normal distribution.

FIG. 3 is another exemplary plot illustrating of a robust performance of the present invention's method in statistical simulation using different sets of predictors (e.g., 10 predictors, 20 predictors, and 30 predictors) versus the existing Cox model, when the predictors have Chi-square distribution.

### DETAILED DESCRIPTION OF THE INVENTION

In some embodiments, the present invention relates to systems, methods, and computer-readable medium for predicting a risk that a certain event will occur over time with regard to an individual. The present invention is concerned with a survival analysis for a plurality or a group of individuals, whereby individuals are ordered according to their risk of “failure”.

In the survival analysis theory, “failure” or an event is referred to as a designated experience of interest that may happen to an individual. The survival analysis also measures time over which individual survived during a follow-up period, i.e., to time to an event. If information about individuals is known, but the survival time is not exactly known (e.g., the event in question does not occur to a particular individual during a particular time frame (i.e., period of study), or individual withdraws from the study, etc.), then that particular individual is considered “censored”.

In the survival analysis, individuals can be characterized by their number, survival time (t), failure/censorship status (δ), and explanatory variables, which are also referred to as predictors or features (Xᵢ) that are specific to each individual within a set of individual being studied. The predictors can include age, weight, height, blood pressure, and any other variables. As can be understood by one skilled in the art, there can be any number and/or any type of predictors characterizing each particular individual in the study. It is typical that the data concerning the set of individuals being studied is represented as follows:

TABLE 1
Example.

| Indiv. # | t | δ | X₁ | . . . | Xₚ |
|---|---|---|---|---|---|
| 1 | t₁ | δ₁ | X₁₁ | . . . | X₁ₚ |
| 2 | t₂ | δ₂ | X₂₁ | . . . | X₂ₚ |
| . . . | . . . | . . . | . . . | . . . | . . . |
| n | tₙ | δₙ | Xₙ₁ | . . . | Xₙₚ |

where the δ has a value of either 0 or 1 and the sum of all δ's represents a total number failures for the entire set of individuals in the study.

A solution of a survival analysis problem generates a scoring function, which increases with the increased risk of failure. Thus, survival analysis is a learning problem, where risk of individuals is estimated as a function of available features (“predictors”). The outcome can be characterized by score of an individual, which orders individuals in accordance with their risk.

Thus, to summarize, the survival analysis problem can be defined as follows. For a set of individuals I, there exists a given set of observations, wherein an observation includes feature values as well as an outcome for a particular individual a. The outcome includes two types of information: a) censoring status (c(a)) and b) target (elapsed) time (t(a)). As stated above, an observation is censored, if an individual did not fail during target time. As also stated above, the censoring status is a binary variable. Thus, a pair of individuals (a, b)εI is in survival order S: a [symbol] b, if a is not censored, and t(a)<t(b). It should be noted that survival order depends on an intrinsic risk of an individual's failure and other random factors. The intrinsic risk order also defines a latent risk order on a general population of individuals to which the set of individuals I belongs. Thus, a goal of the survival analysis is to find a scoring function s(a) for the general population of individuals that is aligned with the latent risk order.

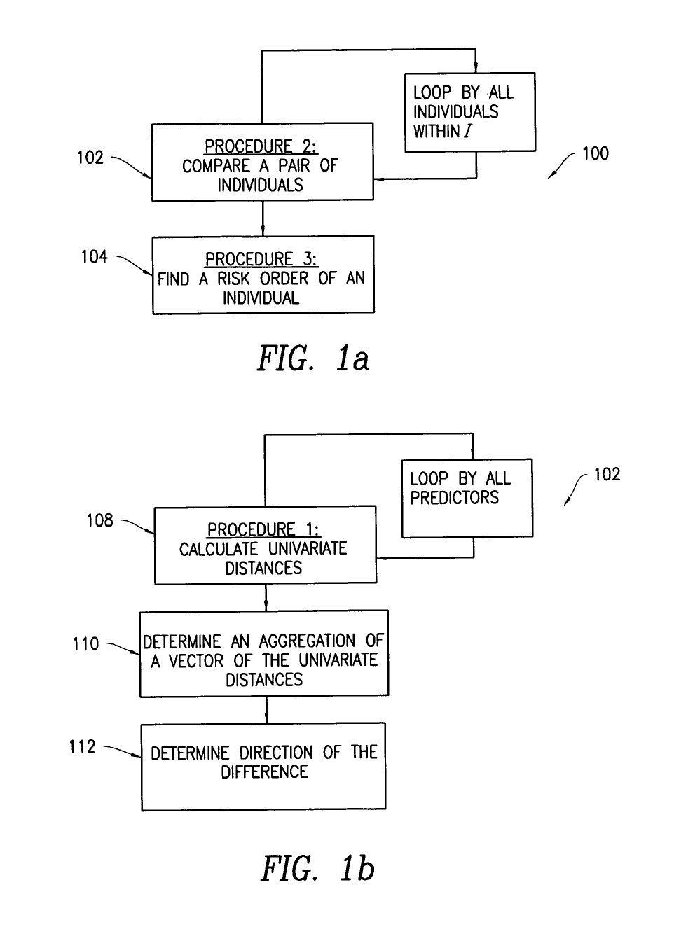

The individuals can be characterized by a plurality of features or predictors (e.g., age, gender, race, blood pressure, etc.). In some embodiments, FIGS. 1a and 1b illustrate an exemplary method 100 performed for a set of n individuals I that are characterized by predictors {ƒᵢ}, wherein i=1, 2, . . . , m, according to some embodiments of the present invention. In some embodiments, the method performs the following three procedures: Procedure 1 (also referred to as a “Univariate Shift Procedure”)—estimate some measure of differences between pairs of individuals by a single predictor; Procedure 2 (also referred to as a “Multi-dimensional Order Procedure”)—order a pair of observations by multiple predictors; and, Procedure 3 (also referred to as a “Scoring Procedure”)—determine a scoring function.

In some embodiments, the present invention's algorithm can be presented as sequence of two steps: Step 102: perform Procedure 2 to compare a new individual with each individual in the dataset; Step 104: perform Procedure 3 to evaluate risk order of the individual based on the results of pair-wise comparisons of Step 102. FIG. 1a illustrates this two-step approach.

In some embodiments, Procedure 2, in turn, includes three steps. Referring to FIG. 1b, in Step 108, some measure of distance between given pair of individuals is estimated for each predictor. In Step 110, an aggregation function is used to find overall distance between the individuals. In Step 112, the result of the comparison is determined based on the value of the overall distance, obtained on Step 110.

For illustration purposes only, assume that dataset n consists of data of 50 individuals and each individual is characterized by 10 predictors. To find a risk order of a new individual, for each of the 50 individuals in the data, in Step 102, the present invention's algorithm determines an order of the new individual in relation to the individual(s) in the data, using Procedure 2.

In order to perform Procedure 2, the algorithm performs Procedure 1 in a loop, as shown in FIG. 1a, finding a distance between the individuals by each predictor, and applies an aggregation function, to find a multi-dimensional distance and to compare the pair of individuals.

After comparing the new individual with each individual in the dataset, the algorithm uses Procedure 3 to find risk order of the new individual, as shown in FIG. 1a.

In some embodiments, Procedure 1 determines a “trimmed difference” d(a,b) between individuals a, b by a single predictor f. This procedure involves a calculation of the difference between feature values for individuals a, b. If |ƒ(a)−ƒ(b)|<μ, then d(a,b)=0. If |ƒ(a)−ƒ(b)|≧μ, then d(a, b)=ƒ(a)−ƒ(b). Here u is referred to as a sensitivity threshold for the given predictor f.

For example, two patients may have values of PSA (“Prostate specific antigen”) biomarker equal to 0.3 and 0.4, respectively. However, it is known that precision of PSA measurement is less than 0.2. The difference between the two values of the first patient and the second patient (i.e., ƒ(a)−ƒ(b)) is −0.1, and, in a traditional approach, the first patient would be considered as having less risk. If sensitivity threshold is set to 0.2, then the patients are incomparable by their risk with respect of this biomarker. This better reflects their true relationship.

Thus, the trimmed univariate differences for a predictor i and a pair of individuals <a, b>, can be expressed as follows:

$${d}_{i} ( a , b ) = \{ \begin{matrix}{f}_{i}^{′} ( a , b ) , & if \vert {f}_{i}^{′} ( a , b ) \vert > μ \\ 0 , & otherwise\end{matrix} \} \qquad ( 1 )$$

where ƒᵢ′(a, b) represents the value of the difference for a particular predictor i.

It should be noted that on simulated and real datasets, univariate performance of continuous predictors improves with an increase of the sensitivity threshold p in large-interval values of u. As the threshold μ increases, more pairs of observations become incomparable by each predictor.

In some embodiments, Procedure 2 may include calculation of an order of two individuals using the following formula:

q(a,b)=sign(U(d₁(a,b), . . . , dₘ(a,b))), (2)

wherein U is an aggregation function. An aggregation or an aggregate function is defined as a function that returns a single value from a collection of input values such as a set. Some examples of common aggregate functions include: mean, count, maximum, minimum, sum, median, voting, consensus, and others. The function sign refers to a direction of the outcome of the aggregate function, i.e., “+” would mean that individual a has a higher risk of encountering event than individual b and “−” would mean that individual b has a higher risk of encountering event than individual a.

In some embodiments, an un-tied aggregation function U′ can be implemented, where function U′ is configured to ignore predictor comparisons (i.e., differences) resulting in a zero trimmed difference on a pair of individuals.

For example, assume that a pair of individuals a and b characterized by nine predictors has trimmed univariate differences of <0, 0, 0, 0, 0, 2, 3, 4, 5>. Looking at the last four out of nine predictors, the individual a has a higher risk than individual b (assuming predictors have a positive correlation with the risk) and the individuals are not distinguishable by other predictors. Thus, it would be desirable to find that the first individual has higher risk than the second individual. Using a median as an aggregation function, it can be determined that individual a has the same risk as individual b. However, considering only four of the predictors (having difference values of 2, 3, 4, and 5) with the trimmed median as an aggregation function, the risk of the individual a is higher (because the differences are positive).

Referring back to FIGS. 1a-b, in Procedure 3, for an individual a given a set n of individuals I characterized by predictors {ƒᵢ}, i=1, . . . , m, the scoring function in some embodiments is defined by:

$$s ( a ) = \frac{{\sum }_{x ε I} q ( a , x )}{n - 1} \qquad ( 3 )$$

wherein q(a, x) is a function of an aggregated order of individuals in the set of individuals n determined in Procedure 2. It should be noted that the score for each individual equals the difference between a proportion of individuals which precede and succeed a given individual in the aggregated order. Upon determination of a score or a rank for each individual using equation (8), the individuals in the set are ordered.

To determine accuracy of the results of the scoring function, a correlation between the scores of individuals and their failure times, is determined using a well-known function called a concordance index (“CI”). CI is an industry standard for determining accuracy of a predictive model. (see, e.g., Harrell F. E. Jr., Califf R. M., Pryor D. B., Lee K. L., Rosati R. A., “Evaluating the yield of medical tests”, JAMA. 247, 1982, pp. 2543-2546). For example, CI=1 designates a perfect order, i.e., a match of the computed order using the scoring function and the actual order, and CI=0.5 designates an absence of order. The higher the value of CI, the more successful the scoring function is.

Comparison of Present Invention Methods with Other Existing Methods as Applied to Existing Datasets

As stated above, there are several known methods for generating predictions in survival analysis, which include the Cox regression, the SVRc regression (see, e.g., Khan, F. M., Zubek, V. B., “Support Vector Regression for Censored Data (SVRc): A Novel Tool for Survival Analysis”, Proceedings of the Eight IEEE International Conference on Data Mining, ICDM 2008, December 2008, pp. 863-868). There also exist several methods for unsupervised aggregation of orders on data, which include the Wittkowsky ranking and an Ailon model (see, e.g., Ailon N., Charikar M., and Newman A., “Aggregating inconsistent information: ranking and clustering”, STOC '05: Proceedings of the thirty-seventh annual ACM symposium on Theory of computing, New York: ACM Press, 2005, pp. 684-693).

Performance of the present invention was compared to these existing methods using various actual data sets relating to groups/sets of individuals characterized by a plurality of predictors (see, Table 4 below). Table 4 illustrates the performance of present invention's method as compared to the Cox, SVRc and Ailon models based on the following publicly available data:

1. Breast cancer WPBC data. This Magnasarian dataset contains some cytology measurements for breast cancer patients.

2. Melanoma data. This file contains data of a clinical study at the Department of Plastic Surgery, University Hospital of Odense, Denmark. The patients were observed after a skin cancer operation (removal of the tumor and the surrounding skin). (HYPERLINK “http://www.stat.uni-muenchen.de/service/datenarchiv/melanoma/melanomae.html” http://www.stat.uni-muenchen.de/service/datenarchiv/melanoma/melanomae.html).

3. Cirrhosis data. This dataset contains data from the Mayo Clinic trial in primary biliary cirrhosis (PBC). The patients participated in the randomized trial, and their data are largely complete. Out of 17 features, 7 are binary, including the “drug” or “placebo” feature. Since Cox model is not intended to work with missing values, few cases, where some values are missing, were excluded from the training and test subset for Cox regression. (HYPERLINK “http://lib.stat.cmu.edu/datasets/pbc” http://lib.stat.ccmu.edu/datasets/pbc).

4. MSKCC prostate cancer data. This proprietary sample includes information about clinical failure of prostate cancer patients after prostatectomy. The predictors include clinical information as well as measurements from H&E and IF images of patients' prostate tissue.

During this comparison experiment, each of the above data sets was randomly split 50 times into a training subset and a test subset in a proportion of two-thirds to one-third, respectively. In each iteration, the training data were used to train Cox, SVRc models and to select optimal sensitivity threshold for the present invention's method. Then, Cox and SVRc models were applied on the test data; the present invention and Ailon model were used to find order of each individual from the test part against all the individuals in the training part. The results were evaluated using the concordance index between scores of each method on the test individuals with the actual outcome of these individuals. Table 2 results of the above computations:

TABLE 2
Median values of concordance index (“CI”).

| | | | % | | | | Present |
|---|---|---|---|---|---|---|---|
| | # | # | Cen- | Ailon | Cox | SVRc | invention's |
| Dataset | Cases | Predictors | sored | CI | CI | CI | CI |
| WPBC | 194 | 32 | 76 | 0.64 | 0.57 | 0.66 | 0.63 |
| Melanoma | 202 | 5 | 71 | 0.73 | 0.73 | 0.71 | 0.74 |
| Cirrhosis | 312 | 17 | 60 | 0.79 | 0.82 | 0.81 | 0.86 |
| MSKCC | 758 | 40 | 92 | 0.75 | 0.76 | 0.85 | 0.85 |

As can be seen from Table 2, the present invention outperformed other existing methods, such as Cox, Ailon (in most cases), and SVRc (is some cases).

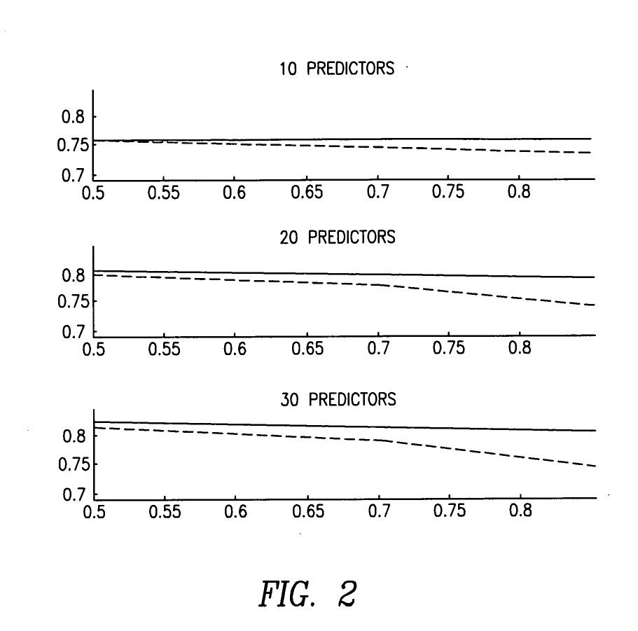

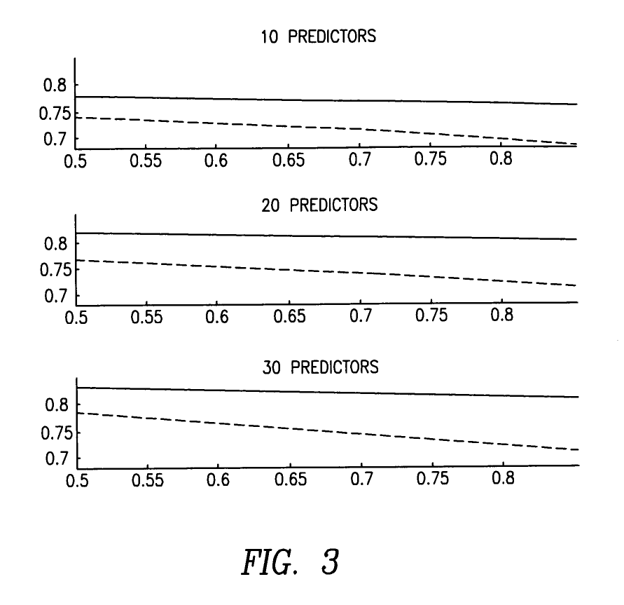

FIGS. 2 and 3 illustrate results of statistical simulation studies for comparison of the performance of the present invention (also referred to as “Robust Ranking method”) with a commonly-used method of survival analysis, Cox proportional hazard regression. In these studies, datasets were randomly generated, simulating available medical data in terms of distributions, correlation between predictors and outcome, censored observations, level of noise in the predictors and the target time, and number of predictors. For each combination of parameters, 25 datasets were generated, with 500 instances in training and 500 instances in validation. The training part was used to train the Cox model and to find optimal parameter for the Robust Ranking method. In the test part, CI was calculated between the generated order and the failure times. FIGS. 2 and 3 plots show that Robust Ranking method has an advantage over the Cox model for all combination of parameters. This advantage increases with the increased number of parameters and rate of censoring.

### Commercial Embodiments

Depending on the particular application, systems that use various embodiments of the present invention may be implemented in order to address prediction problems in survival analysis of individuals characterized by a large number of features and prevalence of censored observations. For example, in order to predict the occurrence of a medical condition in a patient, the present invention may be implemented by suitable computing equipment at a medical diagnostics lab or other facility, where the computing equipment may be operative to receive medical data for a patient and output a prediction for a particular patient. The design of suitable computing equipment should be apparent to one of ordinary skill in the art based on the description herein, and therefore will not be further described.

Insofar as embodiments of the invention described above are implementable, at least in part, using a computer system, it will be appreciated that a computer program for implementing at least part of the described methods is envisaged as an aspect of the present invention. The computer system may be any suitable apparatus, system or device. For example, the computer system may be a programmable data processing apparatus, a general-purpose computer, a Digital Signal Processor or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by means of one or more application specific integrated circuits.

Suitably, the computer program can be stored on a carrier medium in computer usable form, which is also envisaged as an aspect of the present invention. For example, a computer readable medium may be encoded with computer program instructions for performing some or all of the stages of FIGS. 1a-b. The carrier medium may be, for example, solid-state memory, optical or magneto-optical memory such as a readable and/or writable disk for example a compact disk (CD) or a digital versatile disk (DVD), or magnetic memory such as disc or tape, and the computer system can utilize the program to configure it for operation. The computer program may also be supplied from a remote source embodied in a carrier medium such as an electronic signal, including a radio frequency carrier wave or an optical carrier wave. The following examples illustrate predictive ability of the present invention's systems and methods. As can be understood by one skilled in the art, these examples are provided here for purely illustrative purposes and are not intended to limit the scope of the present invention in any way.

It should be noted that the references cited in the above description are all hereby incorporated by reference herein in their entireties.

Example embodiments of the methods and components of the present invention have been described herein. As noted elsewhere, these example embodiments have been described for illustrative purposes only, and are not limiting. Other embodiments are possible and are covered by the invention. Such embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

What is claimed:

1. A method for estimating risk order of an individual, given information about a set of individuals, characterized by one or many predictors, and provided that a direction of association between each predictor and the risk order is known, comprising the steps of:
comparing the individual with each individual within the set of individuals; and,
estimating a risk of an individual based on the comparison.

2. The method according to claim 1, further comprising
performing a Univariate Shift Procedure, wherein a measure of distance between each pair of individuals by a single predictor is calculated;
performing a Multi-dimensional Order Procedure, wherein a pair of individuals, based on univariate shifts, is ordered; and,
performing a Scoring Procedure, wherein a score for an individual is calculated.

3. The method according to claim 2, wherein said Univarite Shift Procedure further comprises calculating a “trimmed distance”:
$${d}_{i} ( a , b ) = \{ \begin{matrix}{f}_{i}^{′} ( a , b ) , & if \vert {f}_{i}^{′} ( a , b ) \vert > μ \\ 0 , & otherwise\end{matrix} \} ,$$
wherein μ is a sensitivity threshold for a given predictor.

4. The method according to the claim 3, wherein the function ƒᵢ′(a,b) on the individuals a, b can be calculated as ƒᵢ(a)−ƒᵢ(b), where ƒᵢ(a) and ƒᵢ(b) are values of the predictor i for the individual a and b, respectively, and provided that all predictors have a positive association with the risk order.

5. The method according to claim 2, wherein the Multi-dimensional Order Procedure further comprises:
determining an aggregate order of the pair of individuals using all predictors using:
q(a,b)=sign(U(d₁(a,b), . . . , dₘ(a,b))),
wherein U is an aggregation function, and m is a number of predictors in the dataset.

6. The method according to claim 2, wherein the Scoring Procedure further comprises, for an individual a in the plurality of individuals, given a set n of individuals I characterized by predictors {ƒᵢ}, wherein i=1, . . . , m, define the scoring function as:
$$s ( a ) = \frac{{\sum }_{x ε I} q ( a , x )}{n - 1}$$
wherein q(a, x) is an order of individuals a and x obtained by application of the Multi-dimensional Order Procedure; and wherein the sum is taken over all individuals in the dataset of individuals I.

7. The method according to claim 5, wherein the aggregated order function is selected from a group including, but not limited to mean, maximum, minimum, sum, median, voting, and consensus.

8. Computer-readable medium encoded with computer program instructions for performing a method for predicting a risk in a survival analysis for a plurality of individuals characterized by at least one predictor, the method comprising:
performing the following procedures:
a Univariate Shift Procedure, wherein a measure of distance between each pair of individuals by a single predictor is calculated;
a Multi-dimensional Order Procedure, wherein a pair of individuals is ordered, based on univariate shifts;
a Scoring Procedure, wherein a score for an individual is calculated.
